(19) United States
(12) Patent Application Publication
(10) Pub. No.: US 2009/0045203 A1
(43) Pub. Date: Feb. 19, 2009

(54) Fireproof data storage apparatus suitable for high ambient temperature environments and/or high wattage data storage devices

(75) Inventor: Donald J. Ehrlich, Lafayette, IN (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Schwab Corp.

(21) Appl. No.: 11/889,481

(22) Filed: Aug. 14, 2007

(51) Int. Cl. E05G 1/00

(52) U.S. Cl. 220/592.01; 312/409

(57) ABSTRACT

The present invention provides a thermally insulated cabinet for protecting electronic data storage devices from damage by accidental and environmental conditions and from intentional acts. This cabinet provides an interior envelope which contains one or more data storage devices surrounded by multiple layers of thermal insulation. The thermal insulation layers allow electrical power, data and device control cabling to access the device, thus permitting real time operation of the device while the device is contained within the inner envelope. The apparatuses include an active cooling system adapted to draw heat from within the interior space. The cooling system utilizes a circulating liquid to draw heat from the interior space, and includes a liquid chiller, means for transferring the circulating liquid through the insulated walls of the cabinet and into and out of the interior space, means for drawing heat out of the interior space and into the circulating liquid, and a liquid pump adapted to cycle the circulating liquid through the liquid chiller, means for transferring, and means for drawing heat. The means for transferring is adapted to be destroyed by an environment fire occurring outside of the cabinet and in so doing seal thermally any holes in the cabinet.

### FIELD OF THE INVENTION

The present invention is directed to an apparatus for protecting computer storage equipment such as disk drives, tape drives and solid state devices from damage or destruction in the event of disaster, including fires. The invention is particularly directed to specially configured cabinetry utilizing a fireproof active cooling means that allows the continuous operation of enclosed computer storage equipment where normal passive diffusion is unsuitable for dissipating the heat normally generated during such continuous operation.

### BACKGROUND OF THE INVENTION

Electronic data continues to displace physical documents as the dominant form of record keeping used, and thus the need for mechanisms to secure electronic data storage systems against physical damage is increasing. Data in electronic form is easier to capture, store, use, and exchange than data that is recorded on printed documents. Importantly, data that is stored in electronic form permits businesses to make decisions and execute transactions based upon “real-time” information that actually reflects current conditions. As electronic commerce and other Internet transactions become more important to businesses, the need to secure, preserve and protect “real-time” electronic data grows more imperative. However, the principal forms of electronic data storage, including optical or disk media, tapes and solid state devices, are all relatively vulnerable to casualty damage and are particularly sensitive to damage through exposure. Environmental extremes such as fire, heat, or contamination can damage these devices irreparably, resulting in the corruption or wholesale loss of vital business information.

The traditional means to preserve documents and other tangible things of value against physical damage is to store them in a secured location, such as a fireproof cabinet or safe. For the protection and preservation of electronic data, one current mechanism, that of a fire-resistant computer storage apparatus, mimics the use of fireproof cabinets and safes. Traditional fire-resistant computer storage apparatuses are often used to store “back up” copies from local computers or networks of a business and thus provide protection against fire damage, contamination, theft or mutilation.

Typical fire-resistant computer storage apparatuses insulate the items contained within it (typically some combination of electronic disc drives, electronic flash storage, or removable computer storage) from theft, accidental or unauthorized destruction, damage or modification. To protect against theft or unauthorized access, fire-resistant computer storage apparatuses surround the protected items with barrier materials such as concrete and steel and provide complex locking systems, much like a traditional safe. Similarly, to protect items from damage in the event of a fire, it is common that fire-resistant computer storage apparatus provide sealed spaces surrounded by materials having low thermal conductivity.

Certain types of fire-resistant computer storage apparatuses have cabinets that preserve and protect electronic data storage devices stored therein from accidental, environmental and other damage while also allowing those data storage devices to communicate with external computing devices while the cabinet is sealed. Thus, these apparatuses operate for data back up purposes in real-time. Such apparatuses are preferable in many circumstances as they permit users to access or update information stored within the devices contained within the apparatus without requiring the opening of the secure cabinet and thus exposure of the data storage devices to the ambient environment. Many such real-time storage apparatuses also operate as a fireproof safe with internal space provided for the user to store documents, removable storage media, or other valuables securely within the cabinet.

Such real-time apparatuses, however, must be carefully crafted to balance concerns regarding protecting the storage devices from external environmental issues, such as fire, while not causing the storage devices to malfunction due to overheating in the confined and sealed space within the apparatus. Understandably, the data storage devices must be provided with adequate protection against thermal and environmental extremes by the cabinet of the apparatus. The cabinets of such apparatuses therefore typically are designed to have an inner space surrounded by thermal insulators and sealed against infiltration by heated gasses or environmental contaminants. To prevent high outside temperatures due to fire from being easily conducted into this inner space, the thermal insulators are chosen from a variety of poor thermal conductors.

When an active component such as a disk drive is operated, however, the drive itself creates heat that must be dissipated. Placing that active storage drive in a heat-insulated and sealed cabinet thus causes the thermal insulation used to protect the drive from external heat damage also to hinder natural dissipation of the heat generated by operation of the drive itself. Generally, the maximum safe temperature for removable media (e.g., tapes, floppy discs, film, etc.) is considered to be up to about 125° F. while that for hard discs is higher, up to approximately 350° F. If the heat is not adequately dissipated, the temperature in the inner space will rise and eventually damage the storage devices (or media, if the cabinet allows additional storage space for such). Thus, any fireproof data storage unit that is designed to be operated in real-time must have mechanisms for dissipating heat caused by its active electronic storage devices. In particular, such mechanisms should be sufficient to keep the internal cabinet temperature at least below 350° F., and, if additional secure storage is desired for removable media, below 125° F.

U.S. Pat. No. 6,158,833 issued to Engler discloses a fireproof data storage system capable of real-time access. The Engler system utilizes a completely passive heat dissipation mechanism that relies on the heat generated by the active storage device to be dissipated by conductivity through the walls of its insulated cabinet at a slow and steady rate. The Engler system teaches a cabinet having an inner space configured to cause heat to flow away from the enclosed storage device via free convection (i.e., air currents caused by air temperature differentials). This heat is then naturally dissipated through the insulated walls of the cabinet at a relatively slow and steady rate in order to keep the storage device within safe operating temperatures.

Due to the laws of thermodynamics, heat generated within the cabinet naturally will flow out through the insulated walls more rapidly the lower the temperature outside of the cabinet (i.e., the ambient room temperature) becomes. Thus, keeping the amount of thermal insulation fixed, systems of the type disclosed by Engler will be suitable only so long as the ambient room temperature is sufficiently low to enable enough heat to flow through the cabinet walls to maintain the storage devices within safe operating temperatures. Understandably, this problem is exacerbated as the number of active storage devices contained within the insulated cabinet multiplies. In a system like that of Engler, the amount of heat generated within the cabinet (assuming an ambient temperature of approximately 75° F.) would need to be limited to approximately 12 watts, which is approximately the amount that is generated by the operation of a single conventional hard disc type electronic storage device, in order to keep internal temperatures safe for removable storage media. Adding additional sources of heat (i.e., additional electronic storage devices) to the inside of the apparatus, and/or increasing the external ambient temperature would cause the internal cabinet temperature to rise above 125° F. and, ultimately, above 350° F. A system like that of Engler, having an internal cabinet temperature safely below 125° F. during operation when the ambient temperature is maintained at approximately 75° F., could see its internal temperature rise to over 350° F. as the ambient temperature rises to as low as 100° F. This would of course risk a failure of the electronic storage device, and thus makes such a system unsuitable for continuous real-time operation in a high ambient temperature environment.

One approach commonly utilized to solve this operational overheating problem for electronic storage devices in general has involved the integration of air conditioning or like cooling systems to control the temperature surrounding the storage device. See, for example, U.S. Pat. No. 4,685,303 to Branc et al., U.S. Pat. No. 4,495,780 to Kaneko et al., and U.S. Pat. No. 5,623,597 to Kikinis et al., which all related to cooling systems for electronic data storage devices. This type of approach, however, has not been adequately adapted to the particular case needs of fireproof, real-time electronic storage apparatuses. Air conditioning and cooling systems by their nature unfortunately introduce various weak points that undermine the ability of the thermally insulated cabinet to protect against the high temperatures caused by fire. Any conduit for allowing air or another cooling fluid to flow into or out of the interior of the cabinet to carry operational heat away likewise serves as a weak point in the insulation that would enable heat (and possibly other contaminants) to penetrate into the interior during a fire or other disaster.

Thus, there remains a need in the art for a fire-resistant computer storage apparatus that provides real-time accessibility, provides adequate thermal protection against environmental fires to preserve one or more data storage devices secured within the apparatus, and has means for removing heat caused by operation of the contained one or more storage devices from the apparatus cabinet such that the apparatus is capable of being utilized in a real-time fashion in high-ambient temperature environments and/or with data storage devices that generate a significant amount of heat.

### SUMMARY OF THE INVENTION

Various embodiments of the present invention relate to a fireproof data storage apparatus that includes a thermally insulated cabinet. The cabinet protects one or more enclosed electronic data storage devices from damage by accidental environmental conditions and from intentional acts, such as an external fire. The cabinet provides an interior space that encloses the data storage devices, and the space is surrounded by layers of thermal insulation sufficient to protect the storage devices from fire. The thermal insulation layers allow electrical power, data and device control cabling to access the devices while the cabinet is closed, thus permitting real time operation of the device while the devices are protected from damage within the interior space.

The apparatuses according to the present invention also include an active cooling system adapted to draw heat from within the interior space. The cooling system utilizes a circulating liquid to draw heat from the interior space, and includes a liquid chiller, means for transferring the circulating liquid through the insulated walls of the cabinet and into and out of the interior space, means for drawing heat out of the interior space and into the circulating liquid, and a liquid pump adapted to cycle the circulating liquid through the liquid chiller, means for transferring, and means for drawing heat.

The means for transferring the circulating liquid provides conduits for passing the circulating liquid through the insulated walls of the cabinet, with chilled liquid flowing into the interior space passing through a first conduit and heated liquid flowing out from the interior space passing through a second conduit. The conduits are formed from a material that may be destroyed by an environment fire occurring outside of the cabinet and which are not thermally conductive. Preferably, the conduits are formed from vinyl tubing. The conduits pass through one or more holes formed in one or more of the insulated walls of the cabinet, and pass the chilled circulating liquid to the means for drawing heat and receive it back from the means for drawing heat as heated circulating liquid.

The means for transferring additionally operates such that the high temperatures caused by an external fire will not only destroy the conduits, but will also automatically seal and, in the process, thermally insulate the one or more holes in the insulated walls of the cabinet. In preferred embodiments, the means for transferring further includes an intumescent material that lines the holes and surrounds the conduits as they pass through the insulated wall of the cabinet. The intumescent material is a material that does not readily burn, but rather undergoes a chemical change when exposed to heat or flames. Such materials when sufficiently heated become viscous and form expanding bubbles that harden into a dense, heat-insulated multi-cellular char. While the liquid conduits are destroyed by the heat of an exterior fire, the intumescent material is not and swells to completely seal the holes, and thus thermally isolates the interior space from the fire in the exterior environment.

The means for drawing heat out of the interior space and into the circulating liquid comprises a third conduit in fluid communication with the first and second conduits, which third conduit enables the circulating liquid to flow through the interior space, and, in particular, in an area immediately surrounding the one or more electronic storage devices. The third conduit is formed from a thermally conductive material to encourage heat to flow out of the interior space and into the relatively cooler circulating liquid. Preferably, the conduit is comprised of metal tubing. Most preferably, the means for drawing heat includes a hollow copper coil in fluid communication with the first and second conduits, and copper plates attached to the coil and running between the one or more storage devices mounted within the interior space to act as heat sinks. This means for drawing heat thus provides a mechanism to cool actively the storage devices during real-time operation so as to permit use of the apparatus with storage devices generating significant operational heat and/or within high ambient temperature environments.

The liquid chiller is in fluid communication with the means for transferring, and is located outside of the interior space, preferably exposed to the exterior environment. The liquid chiller can include, for example, an electric refrigeration unit or an air-cooled unit designed to cool a circulating liquid. The liquid chiller thus receives liquid returning from the interior space and cools it, making it suitable for recirculation back into the interior space. In preferred embodiments, the circulating liquid is water and the liquid chiller comprises a Peltier plate and heat exchanger.

Optionally, to maximize the capacity of the cabinet to absorb external heat during a fire, the walls of the cabinet may include an inner layer of thermal insulation enclosed within the walls of the cabinet that is composed of a phase change material. In extreme temperature situations associated with fire, such phase change materials would absorb additional thermal energy by transitioning from a solid to a liquid.

Additionally, any electrical and data cables (which are necessary for real-time operation of the storage devices) that pass through the insulated walls may be adapted to travel through the walls of the cabinet via a tortuous path to limit the chance of external fire-related heat being transferred by the cables into the interior space. In one such optional embodiment, a serpentine path is provided for the electrical and data cables. The serpentine path substantially increases the thermal energy that can by released by the control wires into the thermal insulators and reduces the risk that these wires will conduct sufficient thermal energy from the outside of the cabinet to damage the data storage device.

In this regard, a first aspect of the invention relates to a fire-resistant electronic data storage apparatus adapted for real-time use. The apparatus includes a cabinet defining an interior space and having thermally insulated walls, and one or more electronic data storage devices mounted within the interior space. The apparatus further includes a liquid chiller adapted to transfer heat from a circulating liquid to the ambient air, and means for transferring the circulating liquid such that the circulating liquid travels into and out of the interior space. The means for transferring defines first and second conduits that carry the circulating liquid through one or more holes in the insulated walls of the cabinet. The apparatus also includes means for drawing heat out of the interior space and into the circulating liquid; and a liquid pump adapted to cycle the circulating liquid through the liquid chiller, means for transferring, and means for drawing heat. The pump, the liquid chiller, the means for transferring, and the means for drawing heat are in fluid communication with one another. The means for transferring is manufactured from intumescent materials and materials that are readily destroyed by fire. The temperatures caused by a fire external to the cabinet will destroy the conduits but the intumescent materials will swell to thermally seal the holes.

A second aspect of the invention relates to a fire-resistant electronic data storage apparatus adapted for real-time use. The apparatus includes a cabinet defining an interior space and having thermally insulated walls, and one or more electronic data storage devices mounted within the interior space. The apparatus also has a liquid chiller adapted to transfer heat from a circulating liquid to the ambient air, and a first conduit adapted to channel chilled circulating liquid into the interior space and a second conduit adapted to channel heated circulating liquid out from the interior space. The first and second conduits comprise tubing passing through one or more holes in the insulated walls of the cabinet. The apparatus further includes means for drawing heat out of the interior space and into the circulating liquid. The means for drawing heat comprises a third conduit adapted to channel the circulating liquid along a path within the interior space. The apparatus also has a liquid pump adapted to cycle the circulating liquid through the liquid chiller and the conduits. The tubing is manufactured from materials that are readily destroyed by fire and are surrounded in the holes by intumescent material. The apparatus is designed such that temperatures caused by a fire external to the cabinet destroys the tubing and the intumescent materials swells to thermally seal the holes.

A third aspect of the invention relates to a fire-resistant electronic data storage apparatus adapted for real-time use. The apparatus includes a cabinet defining an interior space and having thermally insulated walls, and one or more electronic data storage devices mounted within the interior space. The apparatus also has a liquid chiller located outside the interior space and adapted to chill a circulating liquid, and a first conduit adapted to channel circulating liquid from the liquid chiller into the interior space. Further, the apparatus includes a thermally conductive hollow coil inside the interior space and in fluid communication with the first conduit. The coil is adapted to channel the circulating liquid along a path within the interior space proximate to the one or more electronic data storage devices and thereby absorb heat into the circulating liquid from the electronic data storage devices. Also, the apparatus has a second conduit adapted to channel circulating liquid out from the interior space and to a liquid pump. The liquid pump is adapted to cycle the circulating liquid through the liquid chiller, the first conduit, the coil, and the second conduit. The first and second conduits are defined by tubing passing through one or more holes in the insulated walls of the cabinet, and the tubing is adapted to be readily destroyed by fire. The tubing further is surrounded in the holes by intumescent material. Thus, temperatures caused by a fire external to the cabinet destroys the tubing and the intumescent materials swells to thermally seal the holes.

The various embodiments of the invention having thus been generally described, several illustrative embodiments will hereafter be discussed with particular reference to several attached drawings. Additional features of the present invention will become apparent to those skilled in the art upon considering the following description of a preferred embodiment of the present invention that exemplifies the best mode of carrying out the invention.

### BRIEF DESCRIPTION OF THE DRAWINGS

FIG. 1A is a cross-sectional view of a cabinet and other aspects of apparatuses according to certain embodiments of the present invention.

FIG. 1B is a second cross-sectional of the cabinet of FIG. 1A taken along line 1A-1A.

FIG. 2 is a combination cross-sectional view and schematic of an apparatus according to another embodiment of the invention.

FIG. 3 is a perspective views showing the in further detail various aspects of the interior space of one apparatus of the present invention.

FIG. 4 is a cross sectional view of an alternative cabinet design using an electronic wiring preform according to additional embodiments of the present invention.

FIG. 5A and FIG. 5B are black and white photographs showing how intumescent materials utilized in preferred embodiments of the present invention respond to fire.

### DETAILED DESCRIPTION OF THE PREFERRED EMBODIMENTS

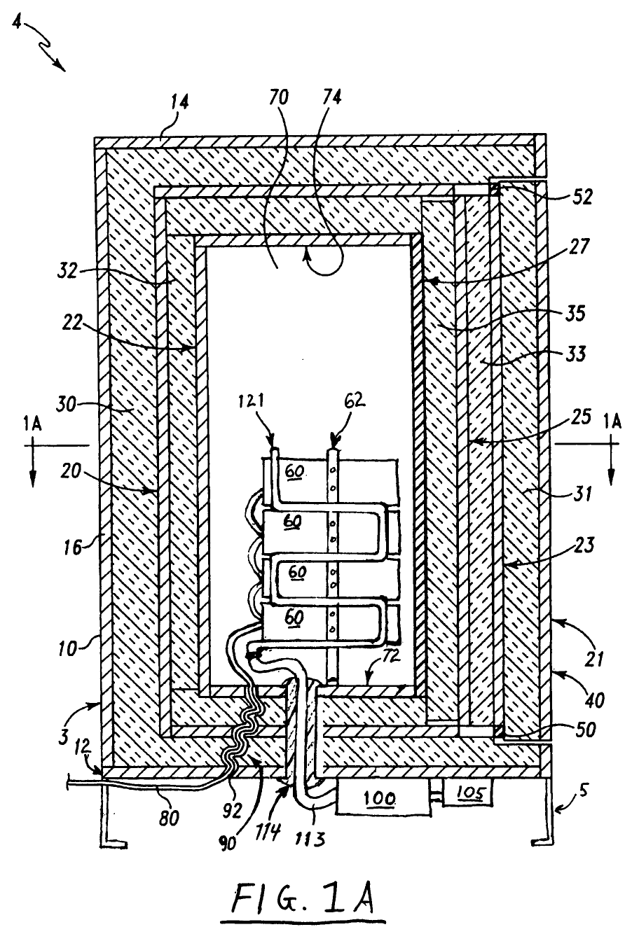

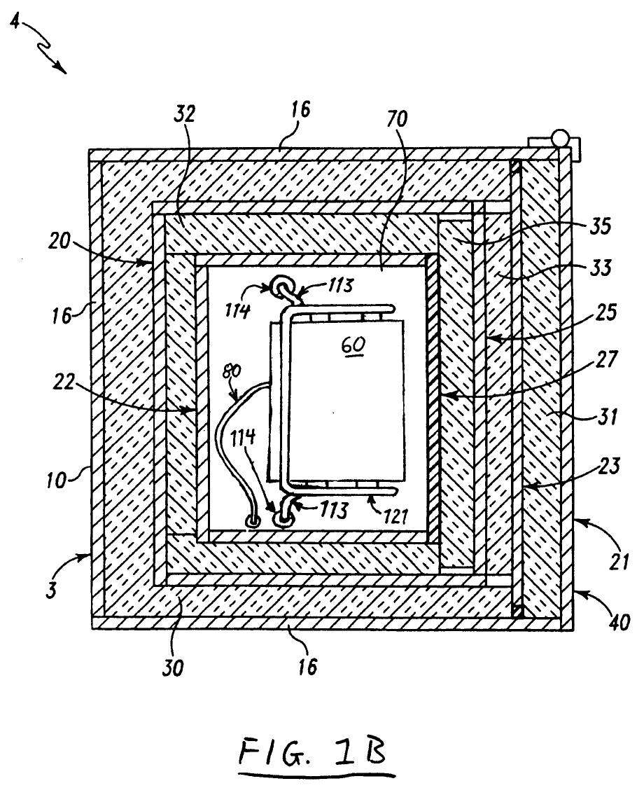

FIG. 1A and FIG. 1B illustrate different cross-sections of a cabinet 4 utilized in one embodiment of the present invention. In the depicted embodiment, an insulated shell 3 is fixed to and rests upon a base 5. The shell 3 includes an outer metal envelope 10 comprising a metal floor 12, and a top 14 separated from the floor by three walls 16 (only one such wall being visible in the cross-section of FIG. 1A). The shell 3 further includes an intermediate metal envelope 20 that is spaced substantially uniformly from the outer metal envelope 10, and a first layer of thermal insulation 30 is deposited between the outer metal envelope 10 and the intermediate metal envelope 20. The shell also includes an inner metal envelope 22 that is spaced inwardly substantially uniformly from the intermediate metal envelope 20 and a second layer of insulation 32 is disposed between the intermediate metal envelope 20 and said inner metal envelope 22.

A door 40 is fixed (such as by hinges and a lockable latch) to the cabinet and forms a substantial portion of a fourth wall of the cabinet 4. The door 40 is shaped for engagement with the shell 3 and is permitted to move relative to the shell 3 to permit manual access to the electronic data storage devices 60 (such as computer hard disc drives, tape drives, or the like) stored in the interior space 70 defined by the shell 3 and door 40. The door 40 is comprised of an outer metal envelope 21, a first insulation layer 31 that is disposed between the outer metal shell 21 and a first intermediate metal envelope 23, a second insulation layer 33 that is disposed between the first intermediate metal envelope 23 and a second intermediate metal envelope 25, and a third insulation layer 35, that is disposed between the second intermediate metal envelope 25 and an inner plastic envelope 27.

The door 40 features seals 50 and 52 to prevent gasses from entering the cabinet 4 by way of gaps formed between the interface of the door 40 and the shell 3.

When door 40 is closed, the inner metal envelopes 22 and inner plastic envelope 27 form a sealed and thermally insulated interior chamber, denoted interior space 70. The chamber has a floor 72, and a ceiling 74, with the electronic storage devices 60 being secured to the floor 72 by component rack 62. The rack can be formed from a material having a relatively low thermal conductivity to prevent heat being transferred from the cabinet 4 to the storage devices 60.

It should be appreciated that the data storage devices 60 could alternatively be positioned proximate to the upper end of the chamber (near or mounted to ceiling 74). However, the mounting of the storage devices 60 near floor 72 is preferred as it enables the exterior elements of the cooling system to be concealed under base 12, as described in further detail below.

To provide sufficient protection of the data storage device 4, the cabinet 4 of the present invention must protect the data storage devices 60 from damage when the cabinet is exposed to extreme external temperatures for a period of at least one hour. Thus, the protective function of the cabinet 4 inherently requires the designer to select insulating materials 30, 31, 32, 33, 35 for the cabinet 4 based upon several defined factors: the external surface area of the cabinet, the expected temperature differential and the requirement that the cabinet 4 protects the data storage device 60 for a period of at least one hour.

Insulation layers 30, 31, 32, 33, and 35 may be composed of various materials having a low degree of thermal conductivity. In one preferred embodiment, insulation layers 30 and 31 are composed of composite insulation, while insulation layers 32, 33, and 35 are composed of an insulator made from urethane foam. Together they produce a composite thermal conductivity calibrated to thermally isolate the electronic storage devices 60 (and optionally any removable media stored in the interior space 70) from external temperature extremes for a minimum of at least one hour. Typically, the insulation lagers would be selected such that they provide a composite thermal conductivity and thermal capacity of between about 0.021 and 0.063 W/m° K.

An active cooling system is integrated with the cabinet 4, and uses a circulating liquid to draw heat from the interior space 70. The active cooling system includes a liquid chiller 100, means 110 for transferring the circulating liquid through the insulated walls of the cabinet (i.e., into and out of the interior space), means 120 for drawing heat out of the interior space and into the circulating liquid, and a liquid pump 105 for cycling the circulating liquid continuously through the liquid chiller 100, means for transferring 110, and means for drawing heat 120.

Pump 105 can comprise any suitable liquid pump known in the art. Optionally, the pump 105 may include temperature sensors that automatically alter flow rate depending upon sensed ambient temperature and/or the temperature of the circulating liquid.

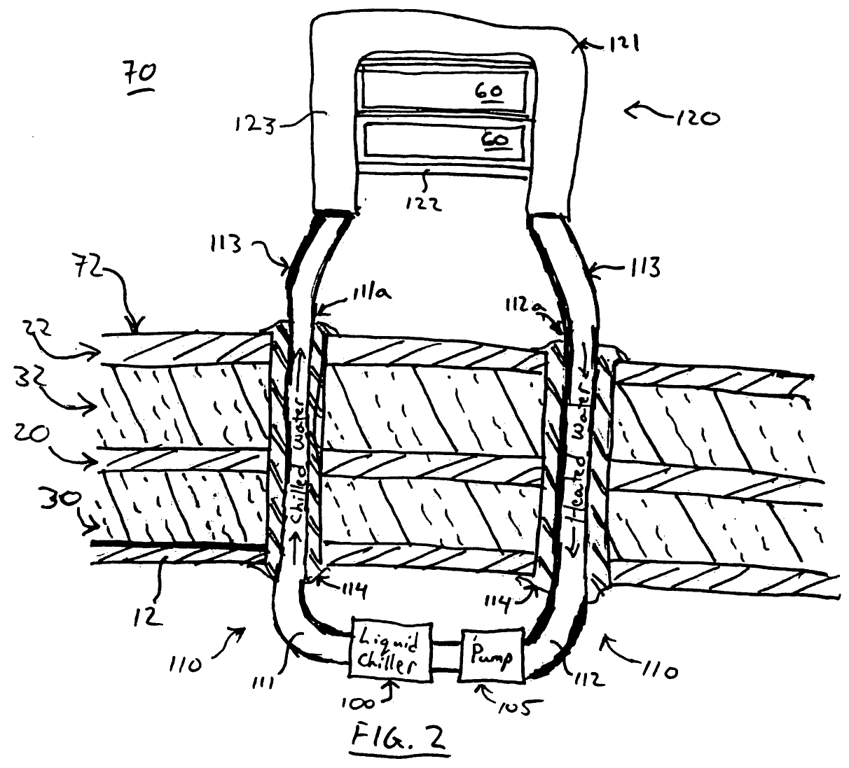

As depicted in detail in FIG. 2, the means for transferring 110 the circulating liquid provides first and second conduits 111 and 112 for passing the circulating liquid through the insulated walls of the cabinet 4 from the liquid chiller 100 to the means for drawing heat 120. These conduits 111 and 112 pass through holes 111a and 112a formed in the bottom of the cabinet 4. This is the preferred configuration because the electronic storage devices 60 are stacked in the bottom of the interior space 70 and the external portions of the active cooling system (namely liquid chiller 100 and pump 105) are concealed below metal floor 12. This configuration is desirable as it reduces the distance that the circulating liquid must travel, and places the liquid chiller 100 and pump 105 where they are both better protected from damage and concealed from view. Of course, this relative location of elements is not necessary for the active cooling system to operate as conceived according to the invention. It should also be appreciated that the location of the pump 105 exterior to the cabinet 4 prevents any heat generated by its operation from negatively impacting the temperature of the interior space 70.

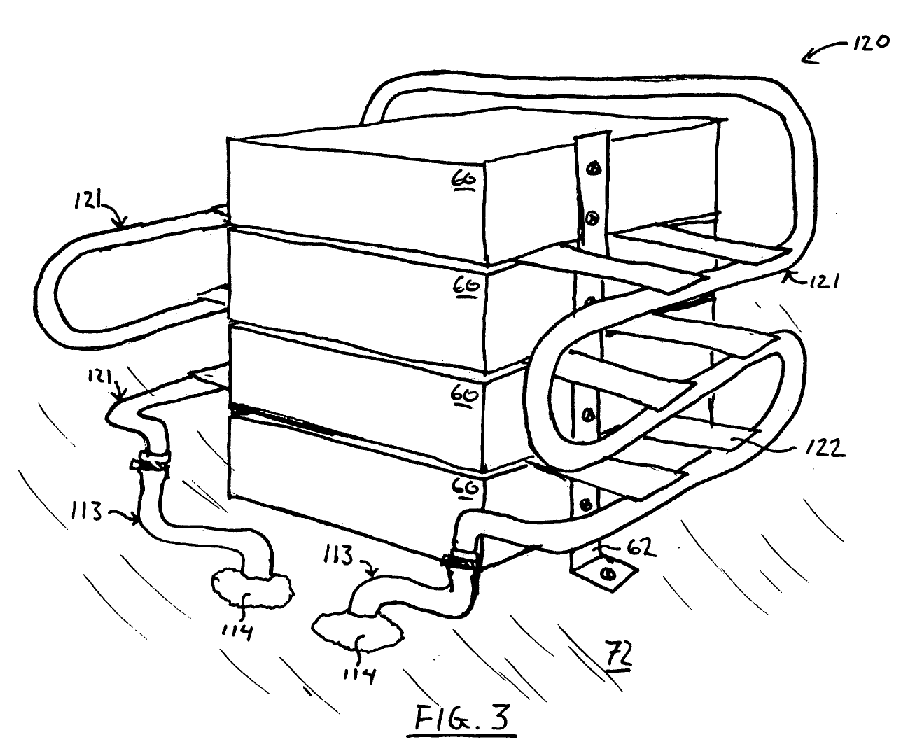

The chilled circulating liquid flows into the interior space 70 through the first conduit 111 and returns after being heated by flowing out of the second conduit 112. The conduits are provided by hollow tubing 113 formed from a material that may be destroyed by a fire occurring outside of the cabinet 4 and which is not itself thermally conductive. Preferably, the conduits are formed from hollow vinyl tubing. As depicted in the various drawings, tubing 113 preferably extends a distance into the interior space 70 away from floor 72 (where tubing 113 connects to hollow copper coil 121 that forms part of the means for drawing heat 120 as depicted in FIG. 3) and away from floor 12 (where tubing 113 connects to liquid chiller 100 and pump 105).

When the electronic storage devices 60 are operational, they generate heat at roughly a constant rate. This heat is radiated into the air within the sealed and thermally insulated interior space 70. Chilled circulating liquid thus passes from the liquid chiller 100, through conduit 111 (formed by tubing 113) and into interior space 70, where it circulates through copper coil 121. The chilled circulating liquid passes through coil 121 and draws heat out of the interior space 70 (assisted by copper plates 122, which act as heat sinks). Heat is thus drawn away from the area immediately about the electronic storage devices 60 in the interior space 70. Heated circulating liquid then exits the copper coil 121 and passes through conduit 112 to pump 105. The heated circulating liquid is then pumped to and through the liquid chiller 100 to cool it, and then the cycle repeats as shown.

In embodiments of the invention, the means for transferring operates such that the high temperatures caused by an external fire will not only destroy the conduits (e.g., by melting vinyl tubing 113), but will also automatically seal and, in the process, thermally insulate the one or more holes 111a and 112a in the insulated walls of the cabinet. In preferred embodiments, the conduits are surrounded in the holes 111a and 112a by an intumescent material that swells in the heat of a fire. One suitable configuration for the means for transferring 110 includes holes in the cabinet wall of approximately 1 inch inside diameter, vinyl tubing having a 1.5 inch outside diameter, and the balance of the holes filled with the intumescent material as depicted. While the tubing is destroyed by the heat of an exterior fire, the intumescent material is not, but rather swells to completely seal the holes 111a and 112a. Thus, the interior space 70 is thermally isolated from the fire in the exterior environment, and the fireproofing of the cabinet is not compromised by the conduits needed by the active cooling system. A suitable intumescent material for use in the present invention includes the Series SSS™ brand intumescent sealant manufactured by Specified Technologies, Inc., of Somerville, N.J., USA.

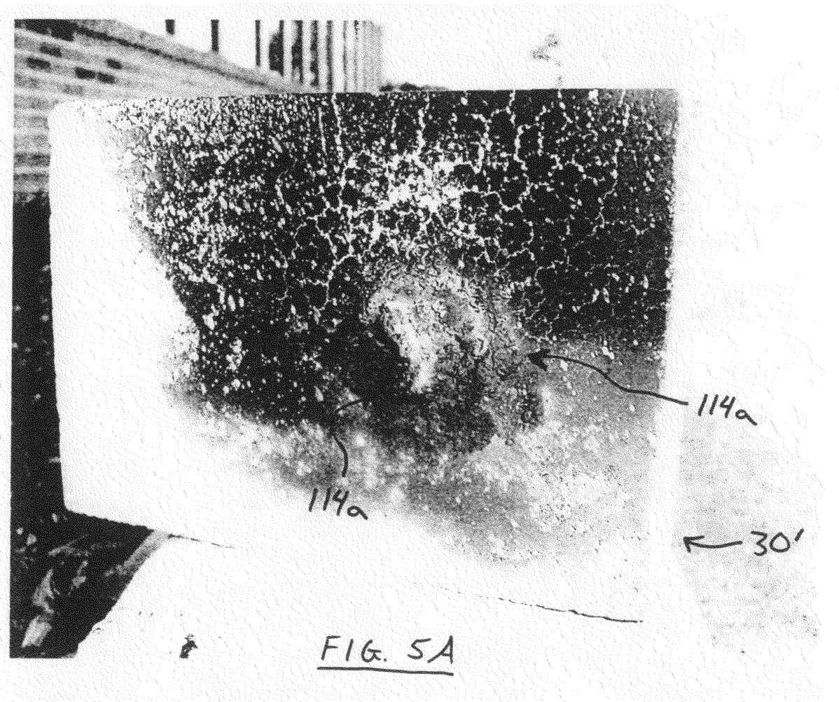

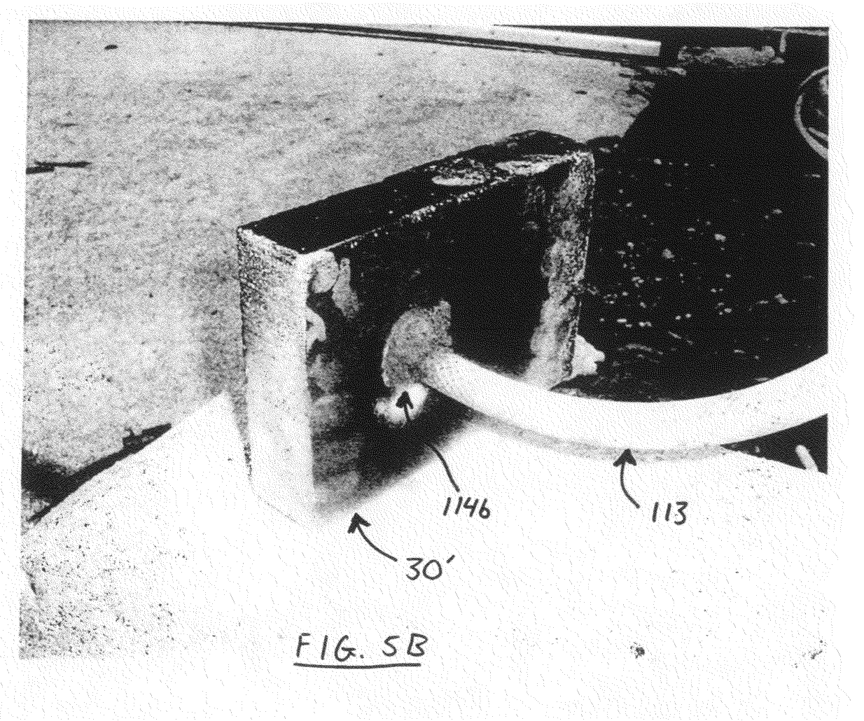

FIG. 5A and FIG. 5B are black and white photographs showing the result of an experiment investigating how intumescent materials respond to fire and seal holes formed in a block of insulative material. An approximately 1 inch inside diameter hole was bored through a block of insulative material 30′, and hollow vinyl tubing 113 having a 0.5 inch outside diameter was threaded through the hole. Intumescent material (Fire Barrier™ brand intumescent sealant) was injected into the hole surrounding the vinyl tubing such that a bit of the material extended out of the hole on either side of the block of insulative material 30′. On side of the block was then directly exposed directly to the flame of a blowtorch for several minutes to approximate the conditions of a fire.

The photograph depicted in FIG. 5A shows the side of the block 30′ that was exposed directly to the fire. It can be clearly seen that the block bears scorch marks, and that the vinyl tubing that had projected out through that side of the block has completely burned away. Further, the intumescent material 114a projecting out that side has expanded and bubbled into a charred mass that completely covers the hole through which the tubing exited. No sign of the hole was visible. In comparison, the photograph depicted in FIG. 5B shows the side of the block 30′ that was not exposed to the blowtorch fire. While the block 30′ bears some carbon marks (due to the small size of the block), it can be seen that the intumescent material 114b projecting out the second side of the block looks as it did before the blowtorch fire was applied. Further, the tubing 113 shows no fire or heat damage.

The means for drawing heat 120 out of the interior space and into the circulating liquid comprises a third conduit 123 in fluid communication with the first and second conduits 111 and 112. The third conduit (e.g., formed by hollow copper coil 121) enables the circulating liquid to flow through the interior space 70, and, in particular, in an area immediately surrounding the one or more electronic storage devices 60. The third conduit is formed from a thermally conductive material to encourage heat to flow out of the interior space and into the relatively cooler circulating liquid. As shown in perspective in FIG. 3, it is preferred that the means for drawing heat 120 includes heat sinks, such as copper plates 122, to help draw heat from the interior space 70 into the circulating fluid. The copper plates 122 used in particularly preferred embodiments attach to the copper coil 121 and run between the one or more storage devices 60.

Because the apparatuses of the present invention are intended to provide real-time access to the electronic data storage devices 60, it is necessary for electric cables 80 (e.g., for data communication and power supply) to be routed from the outside and into the interior space 70. As described in U.S. Pat. No. 6,158,833 issued to Engler, most electrical and data cables are made at least partially of metal materials because of their electrical conductivity. Moreover, the metals used in these cables tend to be good thermal conductors. Thus, there exists the risk that the cables 80 will become heated by exposure to a fire outside of the cabinet 4 and will convey this heat to damage a data storage device located within the interior space 70. Thus, it should be appreciated that the passageway 92 through the insulated walls via which the cables 80 are routed itself can provide a pathway permitting the entry of heated gasses as the cables 80 melt.

In this regard, in preferred embodiments of the present invention a tortuous path 90 through the thermal insulation is provided to accommodate various electrical power, data, and control cables that must be connected to the device to permit to the data storage device to function. In one particularly preferred embodiment, the tortuous path 90 defines a serpentine path is provided for the cables. The serpentine path substantially increases the thermal energy that can by released by the control wires into the thermal insulators and reduces the risk that these wires will conduct sufficient thermal energy from the outside of the cabinet 4 to damage any of the data storage devices 60.

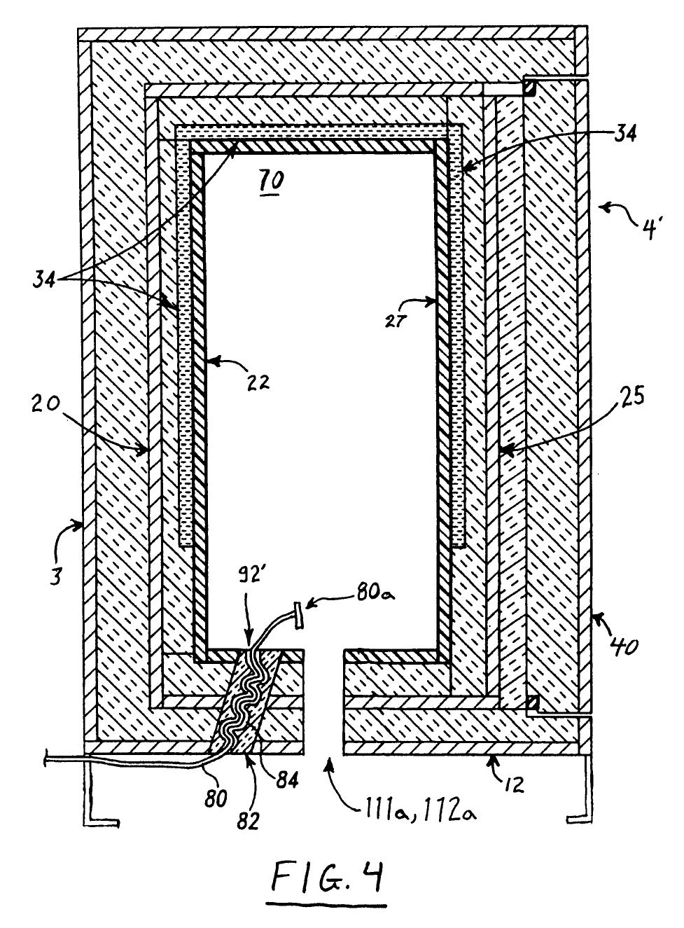

FIG. 4 is a cross sectional view of an alternative cabinet design (shown with the various elements of the active cooling system and electronic storage devices being removed for simplicity) using an electronic wiring preform according to additional embodiments of the present invention. In this embodiment of the invention, a modified cabinet 4′ utilizes a layer 34 of wax to provide additional thermal capacity. In this embodiment, the wax is positioned between the intermediate metal envelope 20 and the inner metal envelope 22 of the shell 3 and between the second intermediate metal envelope 25 and the inner metal envelope 27 of the door 40. The wax layer 34 is carefully selected to absorb energy by changing states from the solid state to the liquid state when confronted with extreme temperatures, and is encased to restrain the wax during its liquid phase.

In other alternative embodiments, the insulative materials 30, 31, 32, 33, and 35 may be selected to include state changing materials to provide additional thermal protection for electronic storage devices 60 located within the interior space 70. These insulators are known as endothermic materials. Such insulators are of particular value when used to provide protection for extreme events such as fire because they absorb substantial amounts of thermal energy during their transition between states. In practice, it has been found that endothermic materials having a phase change temperature in the range between 33° C. and 55° C. are particularly suitable. Examples of such materials include waxes, salts, borax and anhydrous soda ash.

FIG. 4 also depicts an alternative mechanism for achieving the routing of cables 80 without compromising the fireproofing of a cabinet. In this embodiment, communications and data cables 80 (depicted as terminating in an optional electrical and data plug 80a within the interior space 70) enter the cabinet 4′ via a hole 92′ that is substantially larger than is necessary to accommodate cables 80.

As is shown in FIG. 4, the hole 92′ between the metal floor 12 and the interior space 70 can be formed to accept a (non-conductive) thermoplastic preform 82. This preform has an exterior for mating with the shell 3, and a serpentine shaped interior pathway 84 to accept and hold cables 80. This will allow external insertion (or pre-casting) of the cables 80 into the preform 82, facilitating assembly of the preform 82 with the pathway 84. In an alternative embodiment, the preform 82 can be formed to permit partial disassembly in order to accept insertion of the cables 80 into the preform 82. In preferred embodiments, the preform 82 can be formed from an intumescent material. In this manner, heat intrusion permitted by the electrical and data cables during a fire is again minimized.

In normal operation of all embodiments described herein, door 40 is closed creating a closed and sealed thermal environment, namely interior space 70. The electronic storage devices 60 are positioned and connected to cables 80 that provide electricity and permit communication with an external computing device. The inclusion of an active cooling system as described above thus creates a stable thermal environment within the cabinet by carrying any excessive thermal energy created by the data storage devices 60 out to the outside environment.

Having described preferred embodiments of the invention it will now become apparent to those of ordinary skill in the art that other embodiments incorporating these concepts may be used. For example, while it is shown that the inflow and outflow tubing is routed through separate holes in the cabinet, it is of course possible to utilize a single hole. Accordingly, it is submitted that that the invention should not be limited to the described embodiments but rather should be limited only by the spirit and scope of the appended claims. Although the invention has been described and illustrated with a certain degree of particularity, it is understood that the present disclosure has been made only by way of example, and that numerous changes in the combination and arrangement of steps or orientation of parts can be resorted to by those skilled in the art without departing from the spirit and scope of the invention, as hereinafter will be later claimed.

What is claimed is:

1. A fire-resistant electronic data storage apparatus adapted for real-time use, the apparatus comprising:
a cabinet defining an interior space and having thermally insulated walls;
one or more electronic data storage devices mounted within said interior space;
a liquid chiller adapted to transfer heat from a circulating liquid to the ambient air;
means for transferring the circulating liquid such that said circulating liquid travels into and out of the interior space, said means for transferring defining first and second conduits that carry said circulating liquid through one or more holes in the insulated walls of the cabinet;
means for drawing heat out of the interior space and into the circulating liquid; and
a liquid pump adapted to cycle the circulating liquid through the liquid chiller, means for transferring, and means for drawing heat;
wherein said pump, said liquid chiller, said means for transferring, and said means for drawing heat are in fluid communication with one another, wherein said means for transferring is manufactured from intumescent materials and materials that are readily destroyed by fire such that temperatures caused by a fire external to said cabinet destroy said conduits but said intumescent materials will swell to thermally seal said holes.

2. The fire-resistant electronic data storage apparatus of claim 1, wherein said conduits are formed from tubing routed through said holes, and surrounded by said intumescent material inside said hole.

3. The fire-resistant electronic data storage apparatus of claim 2, wherein said tubing is adapted to burn away completely in a fire.

4. The fire-resistant electronic data storage apparatus of claim 3, wherein temperatures of a fire causes said intumescent material to expand and thermally seal each said hole as said tubing burns away.

5. The fire-resistant electronic data storage apparatus of claim 2, wherein said holes comprise one inch inside diameter holes, said tubing is one-half inch outside diameter hollow vinyl tubing routed coaxially through said holes, and said intumescent material fills an annular space inside said holes and outside said tubing.

6. The fire-resistant electronic data storage apparatus of claim 2, wherein said tubing is substantially non-conductive of heat.

7. The fire-resistant electronic data storage apparatus of claim 1, wherein said means for drawing heat comprises a hollow coil formed from a thermally conductive material, said coil defining a third conduit and winding in a space immediately about the electronic data storage devices.

8. The fire-resistant electronic data storage apparatus of claim 7, wherein said means for drawing heat further comprises plates formed from a conductive material and attached to said coil, said plates being positioned to extend along sides of said one or more electronic data storage devices.

9. The fire-resistant electronic data storage apparatus of claim 1, wherein said liquid chiller comprises a Peltier plate and heat exchanger.

10. The fire-resistant electronic data storage apparatus of claim 1, wherein said liquid chiller comprises an electric refrigeration unit.

11. The fire-resistant electronic data storage apparatus of claim 1, wherein said circulating liquid is water.

12. A fire-resistant electronic data storage apparatus adapted for real-time use, the apparatus comprising:
a cabinet defining an interior space and having thermally insulated walls;
one or more electronic data storage devices mounted within said interior space;
a liquid chiller adapted to transfer heat from a circulating liquid to the ambient air;
a first conduit adapted to channel chilled circulating liquid into said interior space and a second conduit adapted to channel heated circulating liquid out from said interior space, said first and second conduits comprising tubing passing through one or more holes in the insulated walls of the cabinet;
means for drawing heat out of the interior space and into the circulating liquid, said means for drawing heat comprising a third conduit adapted to channel said circulating liquid along a path within said interior space; and
a liquid pump adapted to cycle the circulating liquid through the liquid chiller and said conduits, wherein said tubing is manufactured from materials that are readily destroyed by fire and are surrounded in said holes by intumescent material such that temperatures caused by a fire external to said cabinet destroys said tubing and said intumescent materials swells to thermally seal said holes.

13. The fire-resistant electronic data storage apparatus of claim 12, wherein temperatures of a fire causes said intumescent material to expand and thermally seal each said hole as said tubing burns away.

14. The fire-resistant electronic data storage apparatus of claim 12, wherein said holes comprise one inch inside diameter holes, said tubing is one-half inch outside diameter hollow vinyl tubing routed coaxially through said holes, and said intumescent material fills an annular space inside said holes and outside said tubing.

15. The fire-resistant electronic data storage apparatus of claim 12, wherein said tubing is substantially non-conductive of heat.

16. The fire-resistant electronic data storage apparatus of claim 12, wherein said means for drawing heat comprises a hollow coil formed from a thermally conductive material, said coil defining said third conduit and winding in a space immediately about the electronic data storage devices.

17. The fire-resistant electronic data storage apparatus of claim 16, wherein said means for drawing heat further comprises plates formed from a conductive material and attached to said coil, said plates being positioned to extend along sides of said one or more electronic data storage devices.

18. The fire-resistant electronic data storage apparatus of claim 12, wherein said liquid chiller comprises a Peltier plate and heat exchanger.

19. A fire-resistant electronic data storage apparatus adapted for real-time use, the apparatus comprising:
a cabinet defining an interior space and having thermally insulated walls;
one or more electronic data storage devices mounted within said interior space;
a liquid chiller located outside said interior space and adapted to chill a circulating liquid;
a first conduit adapted to channel circulating liquid from said liquid chiller into said interior space;
a thermally conductive hollow coil inside said interior space and in fluid communication with said first conduit, said coil adapted to channel said circulating liquid along a path within said interior space proximate to said one or more electronic data storage devices and thereby absorb heat into said circulating liquid from said electronic data storage devices; and
a second conduit adapted to channel circulating liquid out from said interior space and to a liquid pump, said liquid pump adapted to cycle the circulating liquid through the liquid chiller, said first conduit, said coil, and said second conduit;
wherein said first and second conduits are defined by tubing passing through one or more holes in the insulated walls of the cabinet, said tubing being adapted to be readily destroyed by fire;
and wherein said tubing is surrounded in said holes by intumescent material such that temperatures caused by a fire external to said cabinet destroys said tubing and said intumescent materials swells to thermally seal said holes.

20. The fire-resistant electronic data storage apparatus of claim 19, further comprising two or more electronic data storage devices, and wherein said means for drawing heat further comprises plates formed from a conductive material and attached to said coil, said plates being positioned to extend between said electronic data storage devices.
